(19) United States
(12) Patent Application Publication
(10) Pub. No.: US 2006/0209468 A1
(43) Pub. Date: Sep. 21, 2006

(54) Perpendicular magnetic disk apparatus

(75) Inventor: Hiroyuki Naka, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/377,385

(22) Filed: Mar. 17, 2006

(30) Foreign Application Priority Data
Mar. 17, 2005 (JP) 2005-077783

(51) Int. Cl. G11B 5/33; G11B 5/127

(52) U.S. Cl. 360/313

(57) ABSTRACT

According to one embodiment, there is provided a perpendicular magnetic disk apparatus having a magnetic disk including a soft underlayer and a perpendicular magnetic recording layer, and a magnetic head having a write element including a main pole, a return pole and an exciting coil, and a read element including a magnetoresistive film and a pair of shield films disposed to sandwich the magnetoresistive film, in which a magnetic read track width (MRW) which is read by the magnetoresistive film is set to be smaller than a magnetic write track width (MWW) for signals recorded at a maximum frequency.

### CROSS-REFERENCE TO RELATED APPLICATIONS

This application is based upon and claims the benefit of priority from Japanese Patent Application No. 2005-077783, filed Mar. 17, 2005, the entire contents of which are incorporated herein by reference.

### BACKGROUND

1. Field

One embodiment of the present invention relates to a perpendicular magnetic disk apparatus.

2. Description of the Related Art

Magnetic disk apparatuses are perpetually demanded to improve recording densities. A solution to improve the recording density is to reduce the recording track width, thereby increasing the track density. However, as the track density increases, overwrite characteristics become worse. Thus, there is a demand for improvement in overwrite characteristics.

Conventionally, in order to improve the overwrite characteristics, there has been proposed a perpendicular magnetic head which includes, in addition to a main pole and a return pole, a third pole that is provided on the leading side of the main pole with a nonmagnetic film interposed therebetween (see Jpn. Pat. Appln. KOKAI Publication No. 2004-5826). The third pole has a function of reducing magnetic interference on a recording position due to magnetization recorded on the medium on the leading side of the main pole, thus preventing degradation in overwrite characteristics.

In this document, however, no detailed analysis is made on the overwrite characteristics. It is thus unclear whether the overwrite characteristics are enhanced under the most severe conditions. In addition, this perpendicular magnetic head includes the third pole additionally, which makes manufacturing thereof difficult.

There is known a magnetic disk apparatus wherein the magnetic write track width (MWW) is set at 1.0 μm or less, and a difference between the magnetic write track width (MWW) and the magnetic read track width (MRW) is set in a range between 0.2 μm and 0.8 μm (see Jpn. Pat. Appln. KOKAI Publication No. 2002-150507). This document discloses that good overwrite characteristics can be obtained with this design.

This document, however, assumes a longitudinal recording-type magnetic disk apparatus, and is not applicable to a perpendicular recording-type magnetic disk apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not limit the scope of the invention.

FIG. 1 is a perspective view of a magnetic disk apparatus according to an embodiment of the present invention;

FIG. 2 is a cross-sectional view of a magnetic disk according to an embodiment of the invention;

FIG. 3 is a cross-sectional view of a write element and a read element included in the magnetic head according to an embodiment of the invention;

FIG. 4 is a graph showing track profiles after overwrite (OW1) in longitudinal recording and perpendicular recording;

FIG. 5 is a graph showing track profiles after overwrite (OW2) in longitudinal recording and perpendicular recording;

FIG. 6 is a view showing definitions of MWW and MRW;

FIG. 7 is a graph showing a relationship between a recording density and MWW in longitudinal recording and perpendicular recording;

FIG. 8 is a graph showing a relationship between OW2 and a bit error rate (BER) in perpendicular recording;

FIG. 9 is a graph showing Max OW2 and a double peak width (DPW);

FIG. 10 is a graph showing a relationship between Max OW2 and DPW; and

FIG. 11 is a graph showing a relationship between Hc of a magnetic disk and MWW.

### DETAILED DESCRIPTION

Various embodiments according to the invention will be described hereinafter with reference to the accompanying drawings. In general, according to one embodiment of the present invention, there is provided a perpendicular magnetic disk apparatus comprising: a magnetic disk including a soft underlayer and a perpendicular magnetic recording layer; and a magnetic head comprising a write element including a main pole, a return pole and an exciting coil, and a read element including a magnetoresistive film and a pair of shield films disposed to sandwich the magnetoresistive film, wherein a magnetic read track width (MRW) which is read by the magnetoresistive film is set to be smaller than a magnetic write track width (MWW) for signals recorded at a maximum frequency.

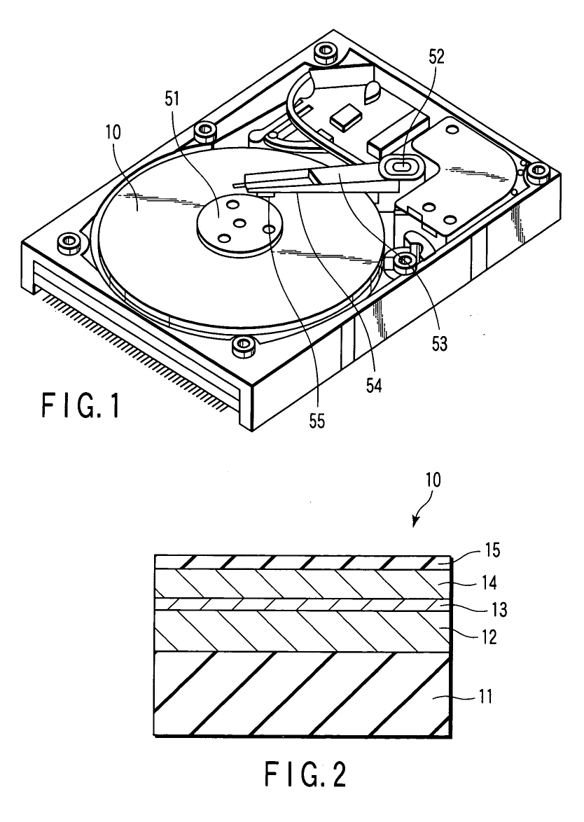

FIG. 1 is a perspective view of a magnetic disk apparatus according to an embodiment of the present invention. In FIG. 1, a magnetic disk 10 is mounted on a spindle 51. An actuator arm 53 is rotatably attached to a pivot 52 that is disposed near the magnetic disk 10. A suspension 54 is attached to a distal end portion of the actuator arm 53. A head slider 55 is supported on a lower surface of the suspension 54. A magnetic head 20 comprising a write element and a read element is disposed on an end face of the head slider 55 so as to face the magnetic disk 10.

FIG. 2 is a cross-sectional view of a magnetic disk according to the embodiment of the present invention. The magnetic disk 10 has a structure that a soft underlayer 12, an orientation control layer 13, a perpendicular magnetic recording layer 14 and a protective layer 15 are stacked in this order on a nonmagnetic substrate 11. Each layer may be composed of a plurality of films. For example, the films may be formed of materials having different compositions.

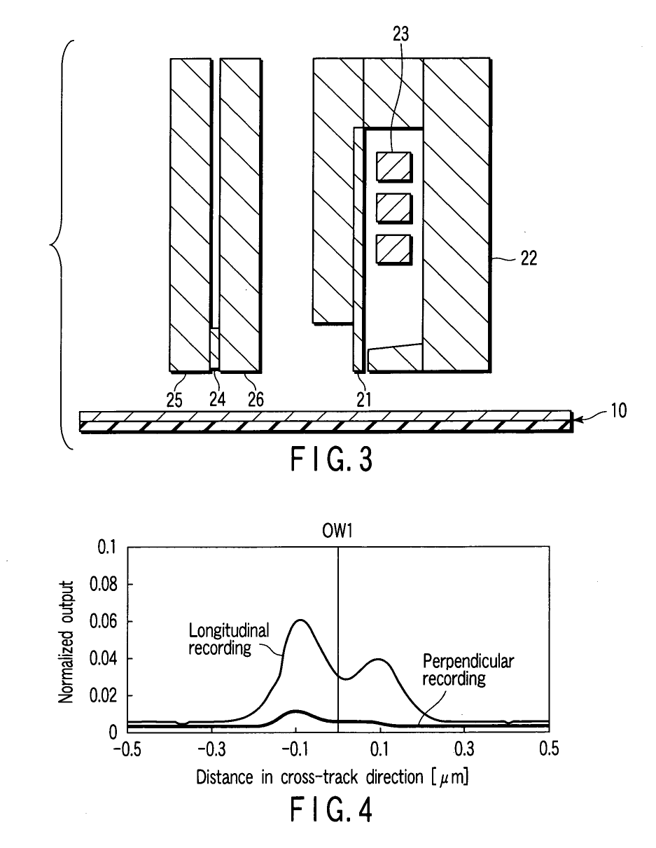

FIG. 3 is a cross-sectional view of the write element and read element included in the magnetic head 20 according to the embodiment of the invention. The write element includes a main pole 21 which is formed of a high-permeability material that generates a perpendicular magnetic field to the magnetic disk 10; a return pole 22 which is disposed on the trailing side of the main pole 21 and has a function to efficiently close a magnetic path via the soft underlayer immediately below the main pole; and an exciting coil 23 which is wound around the magnetic path including the main pole 21 and the return pole 22. The return pole 22 may alternatively be disposed on the leading side of the main pole 21. The read element includes a magnetoresistive film 24, and shield films 25 and 26 which are disposed on the trailing side and leading side of the magnetoresistive film 24 so as to sandwich the magnetoresistive film 24. Signals read by the read element are processed with a built-in signal processing system.

Next, overwrite (OW) characteristics of the magnetic disk apparatus will be described. The OW characteristics are defined as follows: When a recording pattern A with a certain frequency is first written and then a recording pattern B with a frequency different from that of the recording pattern A is overwritten on the recording pattern A, the OW characteristics are expressed by a difference in amplitude of the signal pattern A before and after overwrite. The OW characteristics are an index for evaluating the recording performance of the magnetic head.

Herein, “OW1” is referred to as a case where a recording pattern at a low frequency (LF) is overwritten by a recording pattern at a high frequency (HF), and “OW2” is referred to as a case where a recording pattern at a high frequency (HF) is overwritten by a recording pattern at a low frequency (LF).

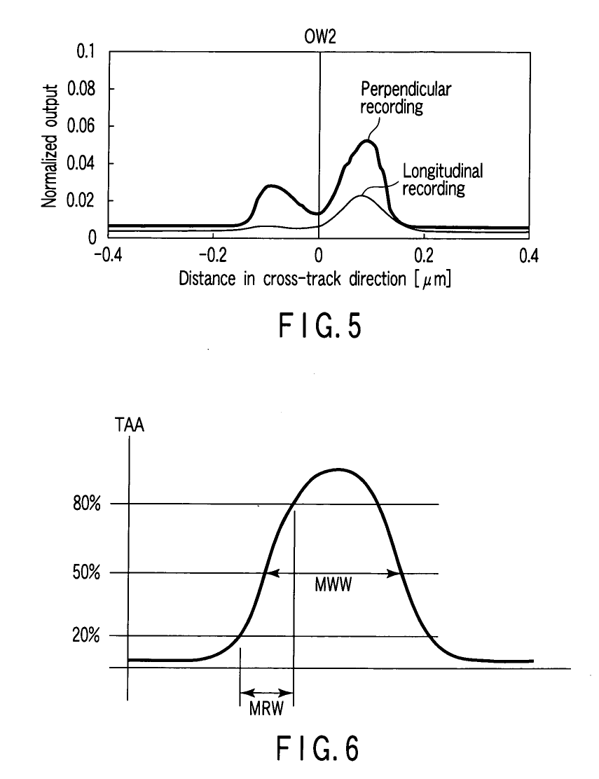

FIG. 4 and FIG. 5 show examples of track profiles of a first signal after the first signal is overwritten by another signal. FIG. 4 shows a track profile of an output of a remaining unerased recording pattern at 80 kFCI in a case where the recording pattern at 80 kFCI is overwritten by a recording pattern at 950 kFCI (OW1). The ordinate indicates the output normalized with the peak value of the initial output of the recording pattern at 80 kFCI. FIG. 5 shows a track profile of an output of an unerased recording pattern at 470 kFCI in a case (OW2) where the recording pattern at 470 kFCI is overwritten a recording pattern at 60 kFCI. The ordinate indicates the output normalized with the peak value of the initial output of the recording pattern at 470 kFCI. Each of FIG. 4 and FIG. 5 shows results obtained in longitudinal recording and perpendicular recording.

Next, the definitions of a magnetic write track width (MWW) and a magnetic read track width (MRW) herein are described. FIG. 6 shows a read output waveform of a signal recorded at a recording density of, for example, 80 kFCI which is read by scanning the read head in the cross-track direction. MWW is defined as a width of a read output waveform at 50% of the read output peak. MRW is defined as a width of a read output waveform of a range within which the read output rises from 20% to 80% (or falls from 80% to 20%).

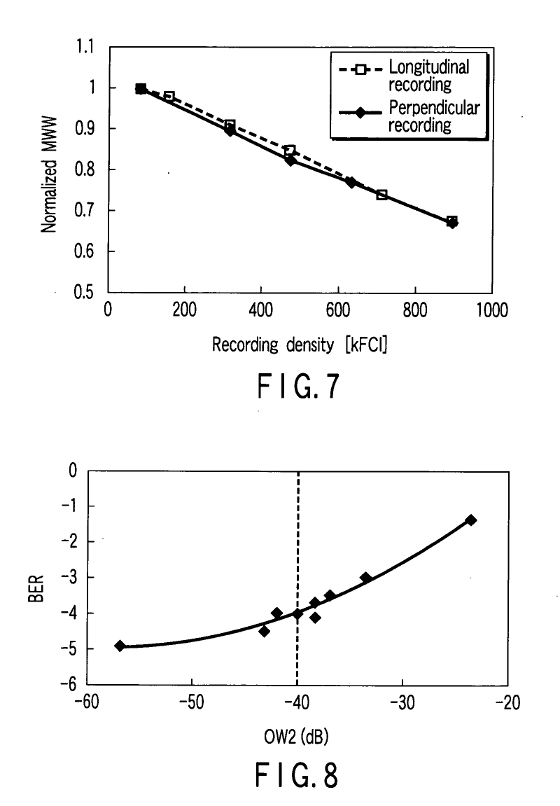

FIG. 7 shows the relationship between the recording density and MWW in longitudinal recording and perpendicular recording. MWW is normalized assuming that MWW of a recording pattern at 80 kFCI is unity.

Referring to FIG. 4, FIG. 5 and FIG. 7, a difference in OW characteristics between longitudinal recording and perpendicular recording is described.

1. Longitudinal Recording

As is shown in FIG. 7, in the longitudinal recording, MWW decreases as the recording density becomes higher. As shown in FIG. 4, under OW1 in the longitudinal recording, an LF pattern with a wide MWW is overwritten by an HF pattern with a narrow MWW, and as a result an unerased component is left remained at an edge of the first LF pattern. Conversely, as shown in FIG. 5, under OW2 in the longitudinal recording, an unerased component hardly occurs when an HF pattern with a narrow MWW is overwritten by an LF pattern with a wide MWW on. Thus, most of the non-erased component left remained after overwriting in the longitudinal recording is the LF component, and edge noise occurs at positions apart from the track center.

2. Perpendicular Recording

As is shown in FIG. 7, in the perpendicular recording, like the longitudinal recording, MWW decreases as the recording density becomes higher. In addition, the recording density dependency of MWW in the perpendicular recording is substantially the same as in the case of the longitudinal recording. However, as shown in FIG. 4 and FIG. 5, the overwrite characteristics in the perpendicular recording are degraded under OW2 rather than under OW1. The reason why the overwrite characteristics are degraded under OW2 is as follows. That is, in the perpendicular recording, more stable magnetostatic coupling occurs in the HF pattern, which makes it hard to erase the HF pattern, and the magnetic field intensity is weaker at the track edges than at the track center. Thus, most of the unerased component left remained after overwriting in the perpendicular recording is the HF component. Besides, since the MWW of the HF component is narrow, edge noise occurs at positions near the track center.

As described above, in the case of the perpendicular recording, OW characteristics are degraded under OW2 in which the LF pattern is overwritten by the HF pattern, and edge noise of the HF component remains. The edge noise forms double peaks. In order to improve the OW characteristics, it is necessary to design the MRW so as not to read the edge noise. Such a design principle in the perpendicular recording differs from that in the longitudinal recording.

An embodiment of the present invention provides a perpendicular magnetic disk apparatus in which MRW is set to be smaller than MWW of a signal recorded at a maximum frequency (1T), and prevents degradation of a bit error rate (BER) due to edge noise caused by an unerased component (HF component). In the case where the recording frequency is expressed by nT, assuming that the maximum frequency is Fmax [MHz], the recording frequency is defined by nT=Fmax/n [MHz].

The principle of the present invention will be described below.

FIG. 8 shows the relationship between OW2 and BER in the perpendicular recording. It is found from FIG. 8 that the degradation of BER increases if the absolute value of OW2 falls below 40 dB (hereinafter the value of OW2 is discussed based on the absolute value).

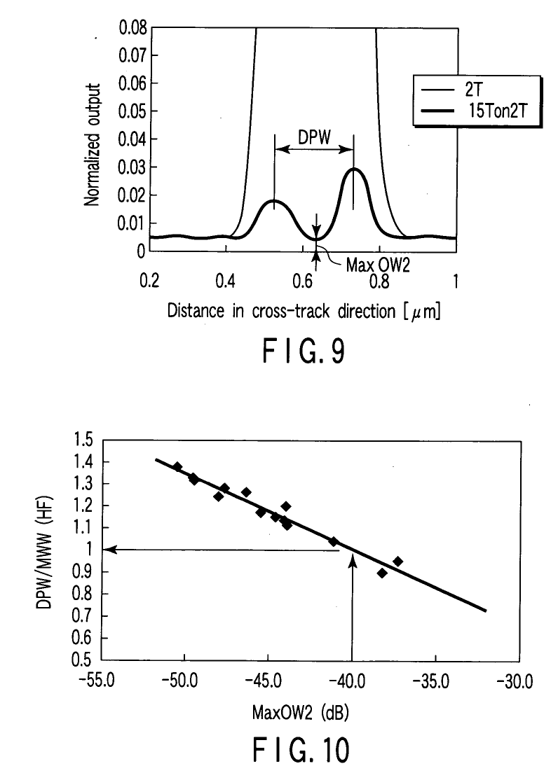

FIG. 9 shows a double-peak width (DPW) of an unerased component and a maximum OW2 value (Max OW2) at the track center. FIG. 9 shows a track profile of an unerased output of a 2T pattern after the 2T pattern is overwritten by a 15T pattern. The ordinate indicates the output normalized with the peak value of the initial output of the 2T pattern.

FIG. 10 shows the relationship between Max OW2 and DPW. DPW is normalized with the MWW of the HF pattern prior to overwriting. It is found from FIG. 10 that Max OW2 worsens as the DPW becomes narrower. As described with reference to FIG. 8, it is preferable that Max OW2 be 40 dB or more. As shown in FIG. 10, when Max OW2 is 40 dB, DPW/MWW(HF) is 1, which means that DPW coincides with MWW of the HF pattern. Hence, it is understood that in order to ensure Max OW2 of 40 dB or more, the magnetic read track width MRW should be set at MWW of the HF pattern or less. In the case of a pattern with a maximum recording density, which is recorded at 1T, the maximum frequency, the signal recorded on the magnetic disk takes a narrowest MWW. In other words, when the first signal is the 1T pattern, DPW takes a minimum value. Accordingly, by setting the MRW at a value not greater than the narrowest DPW, i.e., not greater than MWW at 1T, it becomes possible to avoid occurrence of edge noise caused by an unerased 1T pattern after overwriting, and to enhance the BER. The lower limit value of MRW is determined as a value where sensing of servo signals is made ineffective.

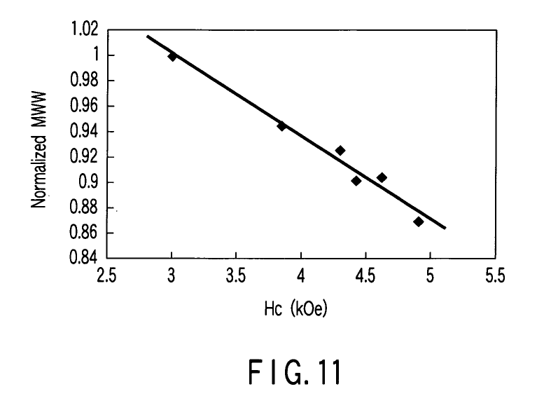

FIG. 11 shows an example of variation of MWW relative to coercivity (Hc) of the magnetic disk. Here, MWW is normalized assuming that MWW is unity when Hc is 3 kOe. Therefore, by examining the variation of MWW relative to Hc of the magnetic disk and the variation of MWW relative to the recording density (recording frequency) as shown in FIG. 7, it becomes possible to estimate the MWW at the maximum frequency 1T and to determine a desirable MRW.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic disk apparatus comprising:
a magnetic disk including a soft underlayer and a perpendicular magnetic recording layer; and
a magnetic head comprising a write element including a main pole, a return pole and an exciting coil, and a read element including a magnetoresistive film and a pair of shield films disposed to sandwich the magnetoresistive film,
wherein a magnetic read track width (MRW) which is read by the magnetoresistive film is set to be smaller than a magnetic write track width (MWW) for signals recorded at a maximum frequency.

2. The perpendicular magnetic disk apparatus according to claim 1, wherein the MRW has a lower limit value determined as a value where sensing of servo signals is made ineffective.

3. The perpendicular magnetic disk apparatus according to claim 1, wherein the MWW is defined as a width of a read output waveform in a cross-track direction at 50% of a read output peak, and wherein the MRW is defined as a width of the read output waveform of a range within which a read output rises from 20% to 80% or falls from 80% to 20%.
